(19) United States
(12) Patent Application Publication
(10) Pub. No.: US 2026/0320374 A1
(43) Pub. Date: Oct. 15, 2026

(54) EFFICIENT ESTIMATION OF ONLINE MACHINE LEARNING MODEL RESULTS USING AN OFFLINE MACHINE LEARNING MODEL

(71) Applicant: GOOGLE LLC, Mountain View, CA (US)

(72) Inventors: Xiaohang Li, Cupertino, CA (US); Yinxiao Li, Palo Alto, CA (US)

(21) Appl. No.: 18/861,640

(22) PCT Filed: Dec. 27, 2023
(86) PCT No.: PCT/US2023/086025

§ 371 Date: Oct. 30, 2024

(51) Int. Cl. G06N 3/08

(52) U.S. Cl. CPC G06N 3/08

(57) ABSTRACT

This specification relates to generating an offline model that approximates the output of an online model. Methods can include constructing a set of query-component pairs. Each query-component pair includes a query and a digital component. An offline model is trained to generate an output that approximates the output of an existing online model. The online model is configured to generate the online output using at least one input parameter that is not used by the offline model. In training, feature weights of the offline model are adjusted based on a difference between the offline outputs and corresponding online outputs that have been generated for digital components by the online model and using the at least one input parameter that is not used by the offline evaluation model. Distribution of digital components is adjusted based on offline output predictions generated after adjusting the feature weights of the offline model.

### TECHNICAL FIELD

This specification relates to machine learning models, including creating models that approximate the output of other models using different sets of parameters.

### BACKGROUND

Machine learning models that are implemented to evaluate content (e.g., images, text, video, etc.), or otherwise operate in a real-time serving environment (e.g., where content is identified and served to a client device within less than a specified number of milliseconds), operation of these models requires significant computing resources to evaluate the content, or otherwise generate a predication, within a specified time constraint. For example, to generate the predication machine learning models generally require a significant amount of energy, computer storage, computer memory, and processing power, particularly in a real-time serving environment.

### SUMMARY

In general, one innovative aspect of the subject matter described in this specification can be embodied in methods including the operations of obtaining a training set of digital components; obtaining a set of queries submitted over a past time period; constructing a set of query-component pairs, wherein each query-component pair in the set of query-component pairs includes a query from the set of queries and a digital component from the set of digital components; training an offline evaluation model to generate an offline output that approximates an online output of an existing online production model, wherein the existing online production model is configured to generate the online output using at least one input parameter that is not used by the offline evaluation model to generate the offline output, including: generating, using the offline evaluation model, the offline output for each query-component pair in the set of query-component pairs to obtain a first set of offline output predictions; and adjusting feature weights of the offline evaluation model based on a difference between the offline outputs in the set of offline output predictions and corresponding online outputs that have been generated for the set of digital components by the existing online model and using the at least one input parameter that is not used by the offline evaluation model; and adjusting a distribution of one or more digital components based on a second set of offline output predictions generated after adjusting the feature weights if the offline evaluation model. Other embodiments of this aspect include corresponding systems, apparatus, and computer programs. These and other embodiments can each optionally include one or more of the following features.

Generating the offline output can include generating a per-query offline output for each digital component in the set of digital components using a set of features of the digital component, wherein the set of features excludes the at least one input parameter used by the online production model to generate the online output. Training the offline evaluation model can include obtaining the online output of the online production model for a set of digital components using the at least one input parameter that is excluded from the set of features used to generate the offline output by the offline evaluation model. Adjusting feature weights of the offline evaluation model can include adjusting parameters of the offline evaluation model in a manner that reduces a difference between the offline output for the set of digital components and the online output for the set of digital components.

Methods can further include generating the set of features used by the offline evaluation model, including concatenating feature embeddings of two or more of image feature embeddings, text feature embeddings, layout feature embeddings, query feature embeddings, or event feature embeddings.

An encoder can be used to determine a feature embedding. The encoder can be at least one of an image encoder, a text encoder, a language model encoder, a layout encoder, or a query feature encoder.

At least one digital component among the set of digital components can be generated by generative artificial intelligence (AI) device.

Methods can further include modifying the AI device, by providing a third set of offline output predictions to the AI device through a feedback mechanism; and adjusting features of one or more new digital components created by the AI device based on feature differences between higher ranked digital components as ranked based on the second set of offline output predictions lower ranked digital components as ranked based on the second set of offline output predictions.

Methods can further include creating a set of combinations of digital components wherein each combination includes at least two digital components selected from the set of digital components; and predicting, using the offline evaluation model, the offline output for each query-combination component pair in the set of query-combination component pairs to obtain a set of offline output predictions.

Methods can further include receiving, from a client device, a given query; determining a combination score for at least one combination of digital components based on the offline output of each digital component included in the at least one combination; and distributing the combination of digital components based on the combination score of the given combination of digital components.

The one input parameter that is not used by the offline evaluation model to generate the offline output can be a parameter that is only accessible online by the online evaluation model.

Particular embodiments of the subject matter described in this specification can be implemented so as to realize one or more of the following advantages. For example, the techniques discussed throughout this specification enable a computer system to develop/train an offline machine learning model that generates an output that approximates the output of an online machine learning model that uses one or more features. More specifically, the techniques discussed herein enable the computer system to create an offline model to approximate the output of an online model even though the online model is using one or more features that are not available to, or otherwise input to, the offline model. For example, in the context of an online system that serves content (e.g., digital components) to client devices, the online system generally uses an identifier (“ID”) tag that has been assigned to each piece of content in combination with other features, such as a received query (or other submitted user request) to evaluate available content and select the content that is served to the user in response to the received query (or other submitted user request). However, an offline model may not have access to the ID tag of content to be evaluated (e.g., the content may not have been assigned an ID tag yet) and since the offline model is operating in an offline environment, there will be no submitted user request. As such, the offline model is not simply a copy of the online model that generates the same output as the online model using the same features. Rather, as discussed throughout this document, the offline model is trained/configured to predict/approximate the output of the online model (e.g., the evaluation of a portion of content) using a different set of features than the online model.

The ability to train the offline model to approximate the output of the online model results in many technical advantages over simply using the online model. For example, the offline model can evaluate a significantly larger number of digital components (e.g., images, text, audio, video, and/or combinations thereof) than the online model in a given time period. Furthermore, resources used to deploy/use the online model can remain dedicated to evaluating digital components being served to client devices rather than evaluating other digital components (e.g., digital components that are not relevant to a current user query or that are newly uploaded to the computer system). As such, the training and use of the offline model reduces the time required to evaluate digital components, and results in a more efficient use of the computing resources that are used to deploy/use the online model.

Another technical advantage resulting from the training/use of the offline model is the ability to reduce the number of digital components that are required to be evaluated by the online model in real-time (e.g., in response to receipt of a submitted user request and/or within a specified serving time constraint). For example, by training and deploying the offline model, the computer system can use the offline model to evaluate a large number of digital components prior to receipt of a submitted user request (e.g., search query), and pre-rank the digital components. In this way, rather than the online model being required to evaluate the corpus of digital components after receiving the submitted user request, the computer system can use the pre-rankings generated using the approximation of the online model generated by the offline model to select and submit a smaller subset of the digital components for final evaluation by the online model. As such, the latency of serving a digital component in response to a user request is reduced relative to a situation in which the offline evaluation and pre-ranking was not performed. Furthermore, the evaluation performed by the offline model can be performed on a per-query basis, such that for any given query, the computer system has already identified/generated the smaller subset of the digital components that should be evaluated for that given query. In this way, the training and use of the offline model results in faster serving that also maintains a high level of digital component quality across different queries. Other technical advantages are discussed throughout the specification.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 illustrates an example environment in which an offline model can be used in the context of serving content to client devices.

FIG. 2 is a block diagram of a system for generating/using an offline model that approximates the output of an existing online model.

FIG. 3 illustrates an example of creating feature sets of digital components for input to the offline evaluation model.

FIG. 4 is a block diagram of an example flow chart of an example process 400 for creating an offline model that approximates an online model.

FIG. 5 is a block diagram of an example computer system.

Like reference symbols in the various drawings indicate like elements.

### DETAILED DESCRIPTION

This specification relates to generating an offline evaluation model that is capable of approximating an online production model even though the set of features used by the offline evaluation model excludes one or more features used by the online production model. By omitting the one or more features used by the online production model from the set of features used by the online evaluation model, evaluation of a digital component (e.g., an image, text, audio, video, etc.) can be performed without the complexity and cost of using an online model for evaluating the digital component. In other words, using the offline evaluation model instead of the online production model to perform the evaluation significantly scales (i.e., increases) the number of digital components that can be evaluated in any given timeframe by orders of magnitude. This is increasingly important as the number of digital components being uploaded to servers continues to increase, and is likely to increase exponentially with the increased use of generative artificial intelligence, which can generate multiple versions of digital components in fractions of a second.

For purposes of this specification, online production models include models that evaluate digital components in response to receipt of a new user submitted query to which the system is being requested to respond to the user (e.g., in an online mode), whereas an offline model can operate independent of a new user submitted query, and instead perform evaluation of digital components in the context of stored user queries to which the system has previously responded. In the online context, the system must respond to the new user submitted query within a specified number of milliseconds to avoid unacceptable delays. In the offline context, the system is not under such a time constraint since a user is not waiting for a response to a newly submitted query.

In current systems, some online production models use a randomly assigned identifier (“ID”) tag of a digital component as a primary input (and potentially as the only input) used to generate the online output for the digital component (e.g., outcome prediction). Generally speaking, these ID tags are assigned to digital components when uploaded to a server, and each uploaded digital component is assigned a different ID tag. Because of the manner in which these ID tags are assigned, similar digital components will have different ID tags, such that the different ID tags do not indicate any similarity between the similar digital components. Rather, each of the similar digital components is fully processed without regard for the similarity. As such, using the ID tags as the input for a model is inefficient compared with techniques that use information inherent in the digital components, such as visual features, audible features, textual features, contextual features, or other features, which can be used to determine similarities between digital components, and therefore, more efficiently process similar digital components. Using an online model also requires significant resources in terms of computer processors, memory, time, and energy. Generally, it is preferable to use fewer such resources to evaluate digital components, particularly when using machine learning models, which can require significant computing resources to train and deploy.

The present disclosure describes the creation of an offline model that outputs similar results as an online model at vastly lower resource costs, for example, by using features inherent to the digital components rather than relying on the ID tags used by the current online models. More specifically, the offline model is trained to predict a metric for a digital component that is as close as possible to the online model's metric of that same digital component without using the ID tags of the digital components, and avoids the disadvantages of using the ID tags in the online model. To train the offline model to approximate the output of the online model, a set of queries from a past time period (e.g., the previous month's top million queries) are assembled (e.g., identified), and a set of query-component pairs are prepared using the set of queries and a set of digital components (e.g., one thousand images). Each query-component pair includes one query from the set of queries and one digital component from the set of digital components. A set of features of the digital component in each query-component pair is fed into the offline model without the ID tag of the digital component, and a prediction output (e.g., offline output) is generated by the offline model. Additionally, the system can look up (or generate) the online output of the online model that is generated using the ID tag of the digital component in each of the digital-component pairs. The offline model can be adjusted in a manner that reduces the difference between the prediction output of the offline model and the online output of the online model, thereby improving the approximation of the online model that is provided by the offline model. When the prediction output of the offline model is sufficiently close to (e.g., withing a threshold amount of) the online output of the online model, the offline model can be deemed an approximation of the online model and used to evaluate and/or rank digital components independent of the online model. For example, when a new digital component is uploaded to the system, the offline model can generate an offline output (e.g., prediction output), which can be used to rank the new digital component among other digital components without requiring the new digital component to be evaluated by the online model. Furthermore, the offline output can be provided through a feedback loop, for example, to a generative artificial intelligence (AI) system, which can use the offline output to automatically improve the digital components generated by the generative AI system, and/or prevent the artificial AI system from wasting resources creating digital components that are evaluated poorly by the offline model (e.g., result in a low offline output when evaluated by the offline model) since these digital components will not be served. Based on the set of returned predicted output scores, a digital component may be ranked or compared to other digital components. For a given set of queries, a set of digital components may be ranked based on the predicted output scores.

The offline model may be trained using any of numerous methods for training models. One example is to use a gradient descent method to calculate the loss between the online model's metric and the offline model's metric, and then to vary the parameters of the offline model to more accurately mimic the output of the online model. Such training methods are resource intensive, but, once the training is completed, the offline model may reproduce nearly the same results at far lower costs in time, energy, and other resources.

One aspect of the present system is that the information from the digital components can be encoded into an embedding (e.g., a vector representation) and that various digital components may have different embeddings which may be concatenated to form a concatenated feature embedding which is used by the offline model to generate the predicted output. In this manner different types of digital components (e.g., images, text, layout) or different features of queries (e.g., web property, browser type, device type, etc.,) may all be included in the information presented to the offline model. Once the offline model has been trained, it can efficiently predict the outputs thereby enabling the system to quickly identify a set of the best digital components to be evaluated by the online model when a request for a digital component is received.

As used throughout this document, the phrase “digital component” refers to a discrete unit of digital content or digital information (e.g., a video clip, audio clip, multimedia clip, gaming content, image, text, bullet point, artificial intelligence output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

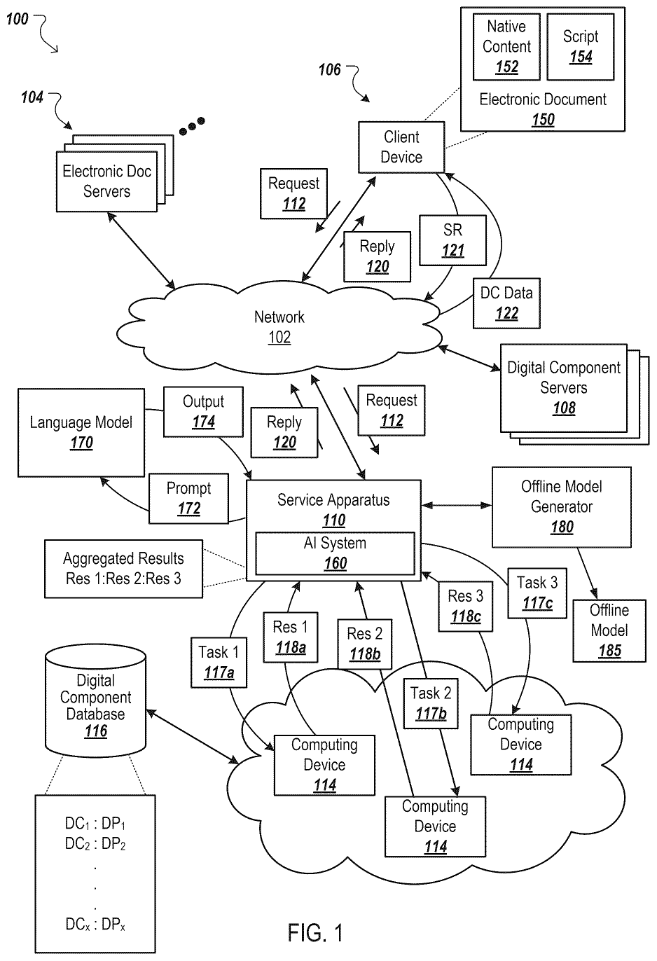

FIG. 1 is a block diagram of an example environment 100 in which an offline model can be used in the context of context of serving content to client devices. For example, using the offline model in the environment would help reduce computer resource demands and enable the evaluation of more digital components relative to using an online model exclusively. The example environment 100 includes a network 102, such as a local area network (LAN), a wide area network (WAN), the Internet, or a combination thereof. The network 102 connects electronic document servers 104, user devices 106, digital component servers 108, and a service apparatus 110. The example environment 100 may include many different electronic document servers 104, client devices 106, and digital component servers 108.

A client device 106 is an electronic device capable of requesting and receiving online resources over the network 102. Example client devices 106 include personal computers, gaming devices, mobile communication devices, digital assistant devices, augmented reality devices, virtual reality devices, wearable computing devices, and other devices that can send and receive data over the network 102. A client device 106 typically includes a user application, such as a web browser, to facilitate the sending and receiving of data over the network 102, but native applications (other than browsers), which are also referred to as “apps”, that are executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally, or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, and respond with content using audible feedback, and can present other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is presenting an electronic document 150. An electronic document is data that presents a set of content at a client device 106.

Examples of electronic documents include webpages, word processing documents, portable document format (PDF) documents, images, videos, search results pages, and feed sources. Native applications (e.g., “apps” and/or gaming applications), such as applications installed on mobile, tablet, or desktop computing devices are also examples of electronic documents. Electronic documents can be provided to client devices 106 by the electronic document servers 104 (“Electronic Doc Servers”).

For example, the electronic document servers 104 can include servers that host publisher websites. In this example, the client device 106 can initiate a request for a given publisher webpage, and the electronic server 104 that hosts the given publisher webpage can respond to the request by sending machine executable instructions that initiate presentation of the given webpage at the client device 106.

In another example, the electronic document servers 104 can include application servers (e.g., native app servers) from which client devices 106 can download apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app, and communicate any user interactions with the user interface back to the cloud server for processing.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) can include a digital component script (e.g., script 154) that references the service apparatus 110, or a particular service provided by the service apparatus 110. In these situations, the digital component script is executed by the client device 106 when the given electronic document is processed by the client device 106. Execution of the digital component script configures the client device 106 to generate a request for digital components 112 (referred to as a “component request” or “submitted user request”), which is transmitted over the network 102 to the service apparatus 110. For example, the digital component script can enable the client device 106 to generate a packetized data request including a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested and characteristics of locations of the electronic document at which digital component can be presented. For example, event data specifying a reference (e.g., URL) to an electronic document (e.g., webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document. The event data can also include a search query that was submitted from the client device 106 to obtain a search results page.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The service apparatus 110 chooses digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script 154) in response to receiving the component request 112 and/or using information included in the component request 112.

In some implementations, a digital component is selected in less than a second to avoid errors that could be caused by delayed selection of the digital component. For example, delays in providing digital components in response to a component request 112 can result in page load errors at the client device 106 or cause portions of the electronic document to remain unpopulated even after other portions of the electronic document are presented at the client device 106. The techniques discussed here, and in particular, the training/use of the offline model, reduce the likelihood that errors are caused by delayed selection of digital components. For example, by using the offline model, a much smaller subset of digital components (e.g., tens of digital components or fewer, rather than hundreds, thousands, or even millions of digital components) are required to be evaluated by the online model before serving one or more digital components in response to a request.

Also, as the delay in providing the digital component to the client device 106 increases, it is more likely that the electronic document will no longer be presented at the client device 106 when the digital component is delivered to the client device 106, thereby negatively impacting a user's experience with the electronic document. Further, delays in providing the digital component can result in a failed delivery of the digital component, for example, if the electronic document is no longer presented at the client device 106 when the digital component is provided. Use of the techniques discussed herein also reduces the likelihood of these types of errors for reasons similar to those discussed above.

In some implementations, the service apparatus 110 is implemented in a distributed computing system that includes, for example, a server and a set of multiple computing devices 114 that are interconnected and identify and distribute digital component in response to requests 112. The set of multiple computing devices 114 operate together to identify a set of digital components that are eligible to be presented in the electronic document from among a corpus of millions of available digital components (DC₁₋ₓ). The millions of available digital components can be indexed, for example, in a digital component database 116. Each digital component index entry can reference the corresponding digital component and/or include distribution parameters (DP₁-DPₓ) that contribute to (e.g., trigger, condition, or limit) the distribution/transmission of the corresponding digital component. For example, the distribution parameters can contribute to (e.g., trigger) the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords that must be matched (e.g., by electronic documents, document keywords, or terms specified in the component request 112) in order for the digital component to be eligible for presentation. Additionally, or alternatively, the distribution parameters can include embeddings that can use various different dimensions of data, such as website details and/or consumption details (e.g., page viewport, user scrolling speed, or other information about the consumption of data). The distribution parameters can also require that the component request 112 include information specifying a particular geographic region (e.g., country or state) and/or information specifying that the component request 112 originated at a particular type of client device (e.g., mobile device or tablet device) in order for the digital component to be eligible for presentation. The distribution parameters can also specify an eligibility value (e.g., ranking score, or some other specified value) that is used for evaluating the eligibility of the digital component for distribution/transmission (e.g., among other available digital components).

The identification of the eligible digital component can be segmented into multiple tasks 117a-117c that are then assigned among computing devices within the set of multiple computing devices 114. For example, different computing devices in the set 114 can each analyze a different portion of the digital component database 116 to identify various digital components having distribution parameters that match information included in the component request 112. In some implementations, each given computing device in the set 114 can analyze a different data dimension (or set of dimensions) and pass (e.g., transmit) results (Res 1-Res 3) 118a-118c of the analysis back to the service apparatus 110. For example, the results 118a-118c provided by each of the computing devices in the set 114 may identify a subset of digital components that are eligible for distribution in response to the component request and/or a subset of the digital component that have certain distribution parameters. The identification of the subset of digital components can include, for example, comparing the event data to the distribution parameters, and identifying the subset of digital components having distribution parameters that match at least some features of the event data.

The service apparatus 110 aggregates the results 118a-118c received from the set of multiple computing devices 114 and uses information associated with the aggregated results to select one or more digital components that will be provided in response to the request 112. For example, the service apparatus 110 can select a set of winning digital components (one or more digital components) based on the outcome of one or more content evaluation processes, as discussed below. In turn, the service apparatus 110 can generate and transmit, over the network 102, reply data 120 (e.g., digital data representing a reply) that enable the client device 106 to integrate the set of winning digital components into the given electronic document, such that the set of winning digital components (e.g., winning third-party content) and the content of the electronic document are presented together at a display of the client device 106.

In some implementations, the client device 106 executes instructions included in the reply data 120, which configures and enables the client device 106 to obtain the set of winning digital components from one or more digital component servers 108. For example, the instructions in the reply data 120 can include a network location (e.g., a Uniform Resource Locator (URL)) and a script that causes the client device 106 to transmit a server request (SR) 121 to the digital component server 108 to obtain a given winning digital component from the digital component server 108. In response to the request, the digital component server 108 will identify the given winning digital component specified in the server request 121 (e.g., within a database storing multiple digital components) and transmit, to the client device 106, digital component data (DC Data) 122 that presents the given winning digital component in the electronic document at the client device 106.

When the client device 106 receives the digital component data 122, the client device will render the digital component (e.g., third-party content), and present the digital component at a location specified by, or assigned to, the script 154. For example, the script 154 can create a walled garden environment, such as a frame, that is presented within, (e.g., beside), the native content 152 of the electronic document 150. In some implementations, the digital component is overlayed over (or adjacent to) a portion of the native content 152 of the electronic document 150, and the service apparatus 110 can specify the presentation location within the electronic document 150 in the reply 120. For example, when the native content 152 includes video content, the service apparatus 110 can specify a location or object within the scene depicted in the video content over which the digital component is to be presented.

The service apparatus 110 can also include an artificial intelligence system 160 configured to autonomously generate digital components, either prior to a request 112 (e.g., offline) and/or in response to a request 112 (e.g., online or real-time). As described in more detail throughout this specification, the artificial intelligence (“AI”) system 160 can collect online content about a specific entity (e.g., digital component provider or another entity) and summarize the collected online content using one or more language models 170, which can include large language models.

A large language model (“LLM”) is a model that is trained to generate and understand human language. LLMs are trained on massive datasets of text and code, and they can be used for a variety of tasks. For example, LLMs can be trained to translate text from one language to another; summarize text, such as web site content, search results, news articles, or research papers; answer questions about text, such as “What is the capital of Georgia?”; create chatbots that can have conversations with humans; and generate creative text, such as poems, stories, and code.

The language model 170 can be any appropriate language model neural network that receives an input sequence made up of text tokens selected from a vocabulary and auto-regressively generates an output sequence made up of text tokens from the vocabulary. For example, the language model 170 can be a Transformer-based language model neural network or a recurrent neural network-based language model.

In some situations, the language model 170 can be referred to as an auto-regressive neural network when the neural network used to implement the language model 170 auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precede the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the neural network of the language model 170 can process the current input sequence to generate a score distribution (e.g., a probability distribution) that assigns a respective score, e.g., a respective probability, to each token in the vocabulary of tokens. The neural network of the language model 170 can then select, as the particular token, a token from the vocabulary using the score distribution. For example, the neural network of the language model 170 can greedily select the highest-scoring token or can sample, e.g., using nucleus sampling or another sampling technique, a token from the distribution.

As a particular example, the language model 170 can be an auto-regressive Transformer-based neural network that includes (i) a plurality of attention blocks that each apply a self-attention operation and (ii) an output subnetwork that processes an output of the last attention block to generate the score distribution.

The language model 170 (or more generally the AI system 160) can be configured to generate an output using a combination of input text alone, or using a combination of text and images, audio, video, or other audio/visual content. For example, the language model can accept the input of an image of a brown dog with the text “generate an image of the dog with white spots.” In this example, the language model 170 can process the image/text input, create a new image of the brown dog with white spots, and output the new image in response to the input. Given the fact that the language model 170 can create such output in a very short period of time, the language model 170 can be used to generate a large volume of modified images and/or text in a very short period of time. This capability to generate such a large volume of images and variations of images has led to a drastic increase in the number of digital components that are available for evaluation by the service apparatus 110. For example, the number of new digital components to be evaluated can grow by the millions in a very short period of time (e.g., seconds, minutes, or hours).

The drastic increase in the number of digital components to be evaluated by the service apparatus 110 (e.g., through expansion of human created and/or uploaded digital components and/or the use of language models) makes it less feasible to exclusively use online models for the evaluation of digital components. For example, the amount of time required to evaluate all of the new digital components would require many more computing resources than was previously used to evaluate digital components. Furthermore, the new digital components do not have any historical serving data (e.g., performance or feedback data) regarding the appropriateness of the new digital components for serving in response to specific user queries. As such, the effectiveness of the online model for evaluating the new digital components will be lower than when evaluating digital components that have been widely served in response to various queries.

Given the challenges of using an online model to evaluate the ever-increasing number of digital components, the service apparatus 110 can be implemented to include, or be in communication with, an offline model generator 180 that is configured to generate an offline model 185, which can be used to evaluate digital components offline. The offline model 185 is trained/created to generate an offline output that approximates the online output of an existing online model. In some implementations, the offline model can be trained to generate the offline output independent of one feature that is used by the online model being approximated by the offline model. For example, the offline model can be trained to generate an offline output using inherent features of the digital component (e.g., audible or visual characteristics) of the digital component, and without using the ID tag of the digital component, which is used by the online model to generate an online output.

As discussed in more detail below, the offline model generator 180 can be initially generated with a first set of feature weights for the inherent features, and the offline output of the offline model 185 can be generated for a given digital component (e.g., a digital component that has been evaluated by the online model). The offline output can then be compared to the online output previously generated for the given digital component using the online model 202 and at least one feature of the given digital component that is not used by the offline model 185 to generate the offline output (e.g., the ID tag of the given digital component). The difference between the online output and the offline output can be used to adjust the feature weights of the offline model 185 in a manner that reduces the difference between the online output and the offline output. This process of generating offline outputs, comparing the offline outputs to the online output, and adjusting the feature weights can continue until the offline output and the online output meet a similarity threshold (e.g., differ by less than a specified amount). At this point, the offline model can be used to evaluate digital components offline (e.g., approximate the online output of the online model), and the offline evaluation can be used to reduce the number of digital components that are required to be evaluated by the online model, as discussed in more detail throughout this specification.

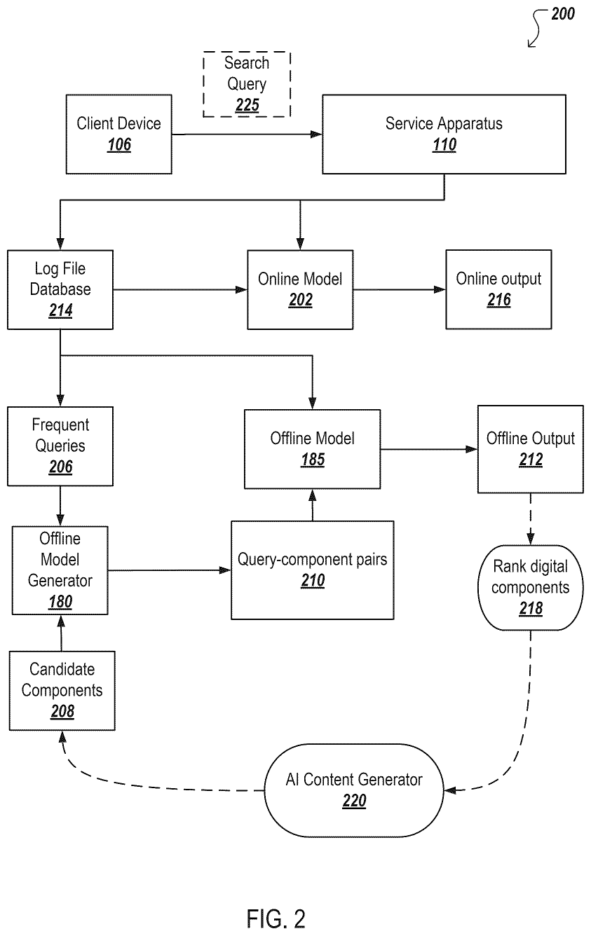

FIG. 2 is a block diagram of a system 200 for generating/using an offline model 185 that approximates the output of an existing online model 202.. The system 200 includes the service apparatus 110 discussed above with reference to FIG. 1. The system 200 also includes an online model 202, which can be implemented as part of the service apparatus 110, or be in communication with the service apparatus 110.

The online model 202 can be an existing online model 202 that has been trained to evaluate digital components, and generate an online output indicative of the suitability of the digital component for serving (e.g., in response to a received query). For example, the online model 202 can accept, as input, an ID tag of a given digital component. As discussed above, the ID tag is a unique identifier for the digital component can be assigned when the digital component is uploaded, or otherwise made available, to the service apparatus 110. Each instance of a digital component, even if having a same set of inherent features as another digital component, can have a different ID tag. As such, the online model 202 treats each instance of a digital component as a distinct digital component rather than being able to leverage data among similar digital components. Data collected about a given digital component can be collected by the service apparatus 110 and stored in a log file database 214. For example, the collected data for the given digital component can be indexed to the ID tag, such that when the ID tag assigned to the given digital component is received, the data collected about the given digital component can be retrieved from the log file database 214 using the ID tag.

The data collected about the given digital component can include features, such as search queries (or other submitted user requests) in response to which the given digital component has been served, a number of instances in which the given digital component has been served in response to each search query, feedback information (e.g., user interaction signals), and/or evaluation outputs of other models (e.g., indications of quality level, emotion invoked by image, likelihood of content of the digital component containing sensitive/inappropriate content, or other evaluation outputs). Some of these features are only available after the given digital component has been served, and some of these features are only available after evaluation by other models. As such, many of these features are not available for digital components that have been newly uploaded, or otherwise made available, to the service apparatus 110. As such, some or all of these features may not be available to an offline model that is not using the ID tag as input and/or evaluating new digital components that have not yet been served and/or evaluated by other models. Furthermore, because each instance of a digital component can have different ID tags, multiple instances of the same collected data may be stored multiple times (e.g., with each ID tag of each similar digital component), thereby leading to storing of duplicate data, which increases the amount of storage capacity required to store the collected information using the ID tags in the context of the existing online model.

The information retrieved from the log file database 214 can be used as input to the online model 202, which is configured to use the ID tag as an input feature and/or to obtain input features. For example, the online model 202 can use the ID tag of the given digital component to retrieve the data collected about the given digital component, which are also considered features of the given digital component, from the log file database 214. In turn, the online model 202 can generate an online output 216 (e.g., an online predication) based on the features of the given digital component retrieved from the log file database 214 and/or the search query in response to which the given digital component is being considered for serving. In some implementations, the online output 216 can be an indication of the appropriateness of the given digital component for serving. For example, the online output 216 can be a prediction of the likelihood of user engagement (e.g., views or clicks) if the given digital component is served. Other predications can similarly be made depending on the context.

For a given search query (e.g., search query 225) received from a client device 106, the online model 202 can evaluate multiple different digital components, and generate an online output 216 for each of the multiple different digital components. In turn, the multiple different digital components can be ranked based on the online outputs 216 of the multiple different digital components, and one or more of the multiple different digital components having the highest ranking can be served in response to the given search query. In some implementations, the online outputs 216 of the multiple different digital components can also be stored in the log file database 214 to train an offline model 185, as discussed below.

The system 200 also includes the offline model generator 180 configured to train/create/generate an offline model 185, which can be implemented as part of the service apparatus 110, or in communication with the service apparatus 110. As discussed above, the offline model 185 can be trained to generate an offline output 212 that approximates the online output 216 of the online model 202 for any given digital component, but without using the ID tag used to generate the online output 216. In some implementations, the offline model 204 can generate the offline output 212 that approximates the online output 216 based on a set of features that does not include the ID tag and/or one or more of the features that are retrievable from the log file database 214 using the ID tag. For example, because the offline model 185 does not use the ID tag, the offline model 185 may also not use all, or in some instances even a subset, of the data indexed to the ID tag of the given digital component in the log file database 214 to generate the offline output 212 for the given digital component. Rather, the offline model 185 can be trained to use a set of inherent features of the given digital component to generate the offline output 212.

As used herein, inherent features of a given digital component include directly observable features of the given digital component. Examples of inherent features of a given digital component can include features such as a color profile, hue, brightness, contrast, or other visual features (e.g., pattern, size, text font, text size, etc.), as well as audio features.

The offline model 185 can be trained to approximate the online output 216 of the online model 202 on a per-query basis. In some implementations, the offline model generator 180 can retrieve a set of the most frequent queries (e.g., the top one million or more queries) and train the offline model 185 to predict the output of the online model 202 for each query in that set of most frequent queries. For example, assume that the top two queries are “dogs” and “cats”. In this example, the offline model generator 180 can train the offline model 185 to evaluate digital components for serving in response to each of these queries. More specifically, the offline model 185 can be trained to approximate the online output 216 that would be generated by the online model 202 if the digital components were evaluated by the online model 202, but using the inherent features of the digital components rather than the ID tag and/or features indexed to the ID tags in the log file database 214. The offline model generator 180 can begin the training process with an initial set of feature weights, and adjust the feature weights in an iterative fashion until a training condition has been met (e.g., a specified number of iterations or a specified level of accuracy). At each iteration, the input to the offline model 185 will be a set of query-component pairs 210, which represent combinations of each query and each digital component. In a specific example, assume that the offline model 185 is being trained on the top 1,000,000 queries, and that there are 1000 digital components (e.g., images) available. In this situation, the offline model generator 180 can create the following query-component pairs 210:<query 1, digital component 1>, <query 1, digital component 2>, . . . <query 1, digital component 1000>, <query 2, digital component 1>, <query 2, digital component 2>, . . . <query 1,000,000, digital component 1>, . . . <query 1,000,000, digital component 1000>. In this way, a separate query-component pair exists for each combination of a query and a digital component.

The set of query-component pairs 210 are input to the offline model 185, and an offline output 212 is generated for each of the query-component pairs 210. For example, the feature weights of the offline model 180 can be applied to the corresponding inherent features of the digital components identified in the query-component pairs 210 to generate the offline output 212 for each query-component pair 210. Since the goal of training the offline model 185 is to obtain an offline output 212 that approximates the online output 212 of the online model 202, without using the ID tag (or at least one other feature used by the online model 202), the performance of the offline model 185 can be evaluated by comparing the offline output 212 generated using the query-component pairs and current feature weights to the online output 216 that has been generated by the online model 202 based on the ID tags of the digital components identified in the query-component pairs 210. More specifically, a mathematical subtraction (or another measure of difference between the offline output 212 and the online output 216 can be determined, and the feature weights of the offline model 185 can be adjusted in a manner that reduces the difference between the offline outputs 212 and the corresponding online outputs 216. This process of generating offline outputs 212, determining the difference between the offline outputs 212 and their corresponding online outputs 216, and adjusting the feature weights of the offline model can iterate until the training condition has been met (e.g., a specified number of iterations have completed and/or a specified level of accuracy has been met).

When the training condition has been met, the offline model 185 can be used to generate offline outputs 212 for new digital components. The new digital components can include digital components that are newly uploaded to the service apparatus 110 and/or digital components that are generated by the service apparatus 110, for example, optionally using an artificial intelligence content generator 220 (e.g., a language model similar to the language model 170 discussed with reference to FIG. 1). As discussed above, the ability to evaluate new digital components using the offline model 202 rather than having to evaluate them using the online model 202 increases the number of digital components that can be evaluated within any given timeframe by orders of magnitude without requiring the level of computing resources needed to use the online model 202.

The ability to evaluate the new digital components using the offline model 185 rather than the online model 202 also enables the use of a feedback loop to the AI content generator 220, which can facilitate continual self-improvement of the AI content generator 220. For example, as discussed above, the AI content generator 220 can generate multiple variants of similar content in which one or more inherent features differ. Each of these variants can be evaluated based on the offline output 212, such as by being ranked 218. The offline output 212 and/or the ranking 218 of the digital components can be provided to the AI content generator 220 by way of a feedback loop, and the AI content generator can auto-adjust its model based on the correlation of different features to differences in the offline output 212 and/or rankings 218. In this way, the AI content generator 220 can self-adapt to more efficiently create content that is expected to be appropriate for serving with different queries. In this way, the AI content generator 220 will use fewer computing resources to arrive at a set of digital components that are appropriate for serving. Also, the amount of storage capacity needed to store digital components generated by the AI content generator 220 will be reduced because the digital components that are lowly ranked can be deleted, rather than storing them for future serving.

Furthermore, the number of digital components that are required to be evaluated by the online model 202 can be reduced because the offline model 185 can be used to identify a set of highest-ranking digital components using the offline scores 212, such that the online model 202 only has to evaluate that set of highest ranking digital components rather than evaluating all digital components. For example, rather than evaluating 1,000 or more digital components when a query is received from a client device, the set of highest-ranking digital components based on the offline output 212 can include a set of 20 (or fewer) digital components, thereby drastically reducing the evaluations required to be performed by the online model 202. This will also lead to lower latency in serving the digital components deemed to be the highest-ranking digital components by the online model 202.

Using the offline output 212 to determine which digital components are evaluated by the online model 202, and therefore, ultimately eligible for distribution by the service apparatus 110 constitutes an adjustment of the distribution of the digital components based on offline output predictions. Additional adjustments to the distribution of the digital components based on the set of offline output predictions can include changing the queries for which a given digital component will be eligible for serving, or otherwise changing distribution parameters of the digital components based on the offline outputs 212 and/or rankings 218.

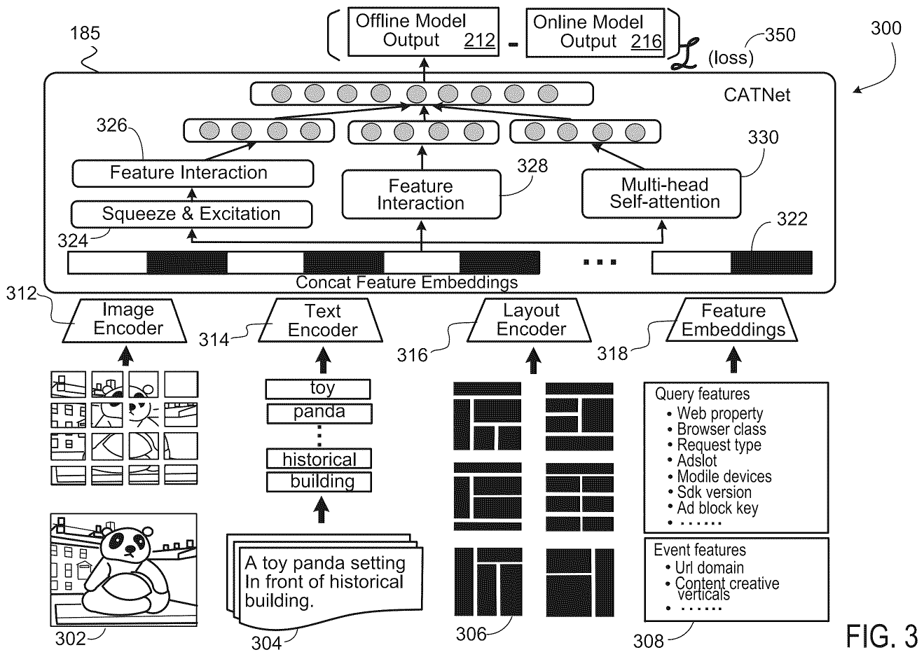

FIG. 3 illustrates an example 300 of creating feature sets of digital components for input to the offline evaluation model 185. Some example digital components include an image 302 and a text 304, and sets of features can include a layout, 306, a query and, an event feature 308. Each digital component can be evaluated individually, or a combination of digital components can be combined into a set of two or more digital components (e.g., text and image) and evaluated together in a similar manner as individual digital components. Each of the digital components (or set of digital components) may be fed into an encoder such as an image encoder 312, a text encoder 314, a layout encoder 316, or a query or feature encoder/embedding 318. These encoders may create embeddings (e.g., vector representations) representing the digital component and/or corresponding features. The embeddings are entered into the offline model 185. The offline model 185 may concatenate the feature embeddings to create a concatenation of feature embeddings 322. In turn, the concatenated feature embeddings 322 are fed into various functions such as squeeze and excitation module 324, a feature interaction module 326 fed from the squeeze and excitation module 324, a feature interaction module 328 fed directly from the concatenated feature embeddings 322, and a multi-head self-attenuation module 330. These modules may produce intermediate outputs which are fed into other modules or layers of the offline model 185, which produce the offline model output 212. This offline model output 212 is compared with the online model output 216 and a loss value 350 is calculated, as discussed above. The calculated loss 350 then enables an adjustment of the parameters (e.g., feature weights) of the offline model 185 and a re-calculation of the loss 350 until the loss 350 falls below a threshold value.

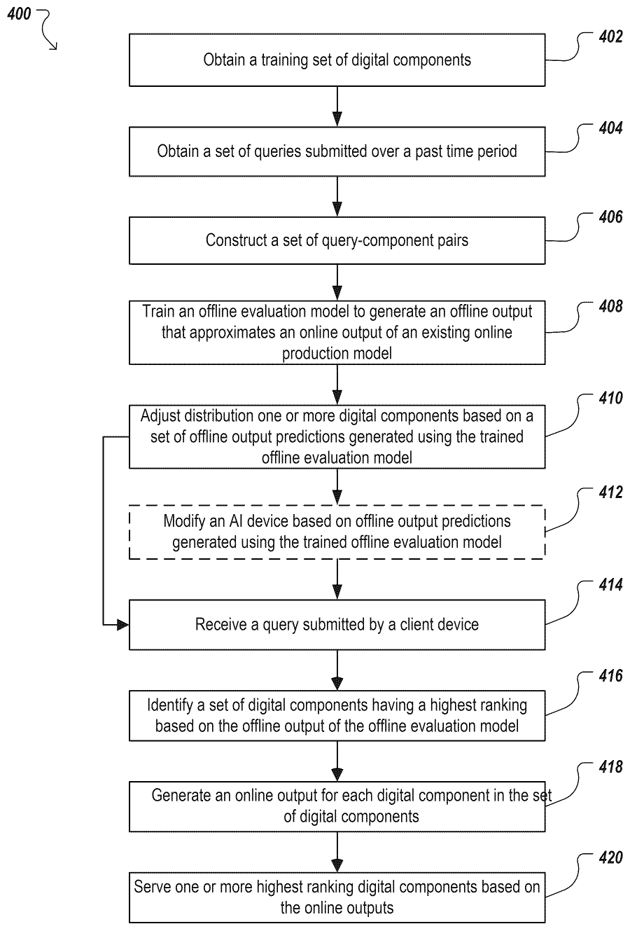

FIG. 4 is a block diagram of an example flow chart of an example process 400 for creating an offline model that approximates an online model. Operations of the process 400 can be implemented by one or more computing devices, such as the offline model generator 180 of FIG. 1. Operations of the process 400 can be implemented as instructions stored on a non-transitory computer readable medium (e.g., non-transitory), such that execution of the instructions cause one or more data processing apparatus to perform operations of the process 400.

A training set of digital components is obtained (402). In some implementations, the training set of digital components can be digital components that were previously provided for distribution. For example, the training set of digital components can be a set of digital components uploaded to the service apparatus 110 of FIG. 1 for distribution. In some situations, the training set of digital components can be digital components that have already been distributed over a specified period of time and/or a specified number of times, such that sufficient historical data has been obtained to generate an accurate online output for the digital components using an existing online model. The training set of digital components can include digital components created and uploaded by a content creator. The training set of digital components can also include digital components generated by an AI device.

A set of queries that were submitted over a past time period are obtained (404). In some implementations, the set of queries can be those search queries that were submitted by a client device over a past day, week, month, year, or other appropriate time period. The set of queries can be, for example, a specified number (e.g., one million or another number) of queries that were most submitted over the past time period. Alternatively, or additionally, the set of queries can be those queries that represent a specified portion of all queries during the past time period. For example, the set of queries can be those most frequent queries that represent at least 75% (or another percentage) of all queries submitted over the past time period. The set of queries can be obtained for example, from the log file database 214 of FIG. 2, which stores historical data regarding past query submission/receipt.

A set of query-component pairs are generated (406). In some implementations, each query-component pair is constructed to include a query from the obtained set of queries and a digital component from the training set of digital components. In some implementations, query component pairs can also be generated for other digital components in a similar manner. As discussed above with reference to FIG. 2, the creation of the set of query-component pairs results in a query-component pair representing each combination of (i) a digital component in the training set of digital components and (ii) a query in the set of queries for the past time period. Constructing the query-component pairs in this way ensures that each digital component is evaluated with reference to each query in the set of queries.

An offline evaluation model is trained to generate an offline output that approximates an online output of an existing online production model (408). In some implementations, the existing online production model is configured to generate the online output using at least one input parameter that is not used by the offline evaluation model to generate the offline output. For example, as discussed above, existing online models generally use the ID tag as an input, and the offline model can be trained to approximate the online output of the online model without using the ID tag and/or information collected and indexed to the ID tag (e.g., in the log file database 214 of FIG. 2). In other words, the offline model can be trained to approximate the output of the online model using inherent features of the digital components rather than relying on the ID tag and historical data corresponding to the ID tag. In this way, the offline model can accurately evaluate new digital components that may not have the historical data relied upon by the online model without having to wait for the collection of historical data.

As part of the training process, the current feature weights of the offline model are applied to the features of the digital components to generate a first set of offline output predictions. The first set of offline output predictions can include, for each of the digital components, an offline output for each query among the set of queries. In other words, the generation of the first set of offline predictions can include generating a per-query offline output for each digital component in the for a set of digital components using a set of features of each digital component. As noted above, the set of features to which the current feature weights are applied will exclude at least one input parameter used by the existing online production model to generate the online output.

The set of features to which the current feature weights are applied can be generated, for example, in a manner similar to that discussed above with reference to FIG. 3. An encoder can be used to determine a feature embedding of a digital component, and the encoder can be one or more of an image encoder, a text encoder, a language model encoder, a layout encoder, or a query feature encoder. In some implementations, a set of feature embeddings of two or more features are concatenated to create the set of features used by the offline evaluation model. As discussed above, the features that are embedded and concatenated can include two or more image feature embeddings, text feature embeddings, layout feature embeddings, query feature embeddings, or event feature embeddings. The concatenated feature embeddings can be input to the offline model, which applies the appropriate feature weights to the appropriate embeddings to create the offline output.

As part of the training process, the online output of the online production model is obtained for the training set of digital components. As discussed throughout this document, the online output is generated by the online production model based on at least one input parameter (e.g., ID tag) that is excluded from the set of features used to generate the output of the offline evaluation model.

The offline evaluation model training also includes the adjustment of feature weights of the offline model based on a difference between the set of offline output predictions and corresponding online outputs that have been generated for the set of digital components by the existing online production model. More specifically, the model adjustment can be performed by adjusting parameters of the offline evaluation model in a manner that reduces a difference between the offline output for the set of digital components and the online output for the set of digital components.

Distribution of one or more digital components is adjusted based on a second set of offline output predications generated after adjusting the feature weights of the offline evaluation model (410). As discussed above, distribution of a digital component can include, including/excluding the digital component in/from a set of highest-ranking digital components as ranked according to the offline outputs, adjusting one or more distribution parameters of the digital component, or otherwise affecting whether/when/how the digital component is distributed to client devices.

In some implementations, an AI device can be modified based on offline output predictions generated by the trained offline evaluation model (412). For example, as discussed above, a feedback mechanism can be used to provide the AI device with the offline outputs and/or rankings of evaluated digital components. For example, the offline output predictions that are generated for a set of digital components generated by the AI device can be provided back to the AI device using the feedback mechanism. The AI device can use this feedback to determine which features of the evaluated digital components lead to higher offline outputs, and adjust the way in which the AI device creates new digital components. For example, based on the offline output, the AI device can adjust features of one or more new digital components created by the AI device based on feature differences between higher ranked digital components as ranked based on the second set of offline output predictions lower ranked digital components as ranked based on the second set of offline output predictions. Furthermore, the AI device can stop creating digital components with features that lead to low offline outputs to reduce the wasted resources that are used generating such digital components and evaluating such digital components. In this way, the offline output can be used to create a more efficient AI content generation system.

Once trained, the offline evaluation model can be used to reduce the number of digital components required to be evaluated by the online model. More specifically, when a query submitted by a client device is received (414), a set of digital components having the highest ranking based on the offline output of the offline evaluation model can be identified (416). As discussed above, this set of highest-ranking digital components can include orders of magnitude fewer digital components than would be eligible for evaluation by the online production model if the offline evaluation model were not used. As such, when the online production model generates an online output for each digital component in the identified set of digital components (418), much less computing resources will be expended, and the latency of evaluating/ranking the digital components based on the online output will be much lower. In turn, one or more highest ranking digital components can be served based on the online outputs (420).

As previously noted, two or more different digital components can be combined to create another digital component, which can be referred to as a “combination component”. For example, assume that text and an image are combined to create a digital component. In this example, the new digital component can be considered a combination component including a text digital component and an image digital component. Although there are multiple content types (e.g., text and image) in the combination component, training the offline model to evaluate combination components and the deployment of the offline model to evaluate/rank the combination component can be carried out in a very similar fashion as described throughout this specification.

For instance, as part of training the offline model, a set of combinations of digital components can be created to include at least two digital components from the training set of digital components. Alternatively, or additionally, the training set of digital components can be created to include pre-existing combination components that each include two or more different digital components or types of content. A set of query-combination component pairs can be constructed in a manner similar to the component-query pairs previously discussed. Then the offline output of the offline model can be generated for each of the query-combination component pairs in a similar manner described above and the training process can be completed in a manner similar to that discussed above.

In some situations, new combinations of digital components (e.g., image and text) may be created at query time based on the context of the query, so as to provide dynamic content that is created especially for a given query instance. In these situations, the specific combination of digital components may not have been previously evaluated as a combination, but the individual digital components may have each been evaluated, such that their individual evaluations can be leveraged to determine a combination score for the combination. For example, when a given query is received from a client device, one or more combinations of digital components (e.g., combinations of images and text) may be created using two or more individual digital components that were evaluated by the offline model, but offline output of the offline model may not have been generated for the combination of digital components. In this example, a combination score can be determined for the combination of digital components based on the offline output of each digital component in the combination, and the combination of digital components can be distributed based on the combination score.

For purposes of example, assume that a textual digital component was evaluated by the offline evaluation model, and had an offline output of 0.6 (on a 1.0 scale), while an image digital component was evaluated by the offline evaluation model, and had an offline output of 0.8. In this example, the combination score for the combination of the text and image can be a mathematical combination of their respective offline outputs. For example, the mathematical combination could be an average of the two offline outputs, a weighted combination of the offline outputs, or another mathematical combination. In some implementations, the highest or lowest offline output among the offline outputs for digital components included in a combination of digital components could be used as the combination score.

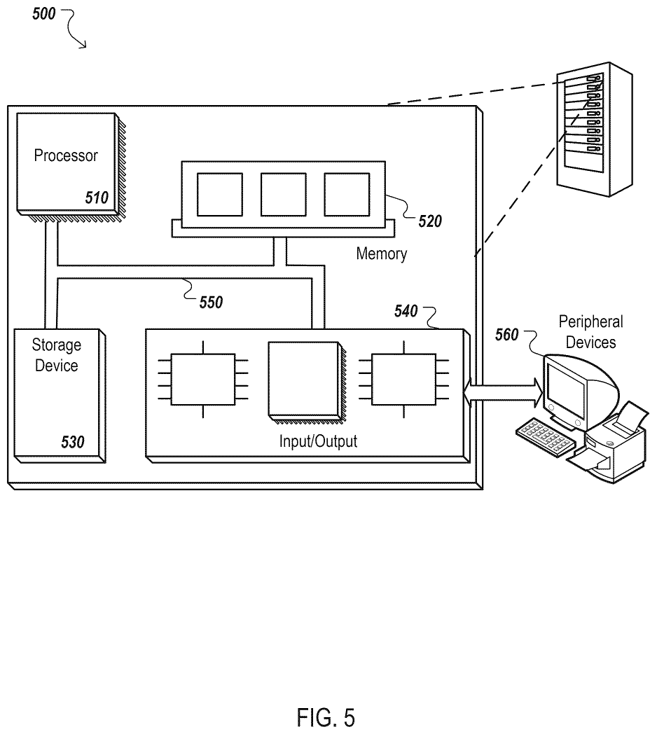

FIG. 5 is a block diagram of an example computer system 500 that can be used to perform operations described above. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, a storage device that is shared over a network by multiple computing devices (e.g., a cloud storage device), or some other large capacity storage device.

The input/output device 540 provides input/output operations for the system 500. In one implementation, the input/output device 540 can include one or more of a network interface device, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 560. Other implementations, however, can also be used, such as mobile computing devices, mobile communication devices, set-top box television client devices, etc.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A method, comprising:
obtaining a training set of digital components;
obtaining a set of queries submitted over a past time period;
constructing a set of query-component pairs, wherein each query-component pair in the set of query-component pairs includes a query from the set of queries and a digital component from the set of digital components;
training an offline evaluation model to generate an offline output that approximates an online output of an existing online production model, wherein the existing online production model is configured to generate the online output using at least one input parameter that is not used by the offline evaluation model to generate the offline output, including:
generating, using the offline evaluation model, the offline output for each query-component pair in the set of query-component pairs to obtain a first set of offline output predictions; and
adjusting feature weights of the offline evaluation model based on a difference between the offline outputs in the set of offline output predictions and corresponding online outputs that have been generated for the set of digital components by the existing online model and using the at least one input parameter that is not used by the offline evaluation model; and
adjusting a distribution of one or more digital components based on a second set of offline output predictions generated after adjusting the feature weights if the offline evaluation model.

2. The method of claim 1, wherein:
generating the offline output comprises generating a per-query offline output for each digital component in the set of digital components using a set of features of the digital component, wherein the set of features excludes the at least one input parameter used by the online production model to generate the online output;
training the offline evaluation model includes obtaining the online output of the online production model for a set of digital components using the at least one input parameter that is excluded from the set of features used to generate the offline output by the offline evaluation model; and
adjusting feature weights of the offline evaluation model comprises adjusting parameters of the offline evaluation model in a manner that reduces a difference between the offline output for the set of digital components and the online output for the set of digital components.

3. The method of claim 2, further comprising generating the set of features used by the offline evaluation model, including concatenating feature embeddings of two or more of image feature embeddings, text feature embeddings, layout feature embeddings, query feature embeddings, or event feature embeddings.

4. The method of claim 3, wherein an encoder used to determine a feature embedding comprises at least one of an image encoder, a text encoder, a language model encoder, a layout encoder, or a query feature encoder.

5. The method of claim 1, wherein at least one digital component among the set of digital components is generated by generative artificial intelligence (AI) device.

6. The method of claim 5, further comprising:
modifying the AI device, including:
providing a third set of offline output predictions to the AI device through a feedback mechanism; and
adjusting features of one or more new digital components created by the AI device based on feature differences between higher ranked digital components as ranked based on the second set of offline output predictions lower ranked digital components as ranked based on the second set of offline output predictions.

7. The method of claim 1, further comprising:
creating a set of combinations of digital components wherein each combination includes at least two digital components selected from the set of digital components; and
predicting, using the offline evaluation model, the offline output for each query-combination component pair in the set of query-combination component pairs to obtain a set of offline output predictions.

8. The method of claim 2, further comprising:
receiving, from a client device, a given query;
determining a combination score for at least one combination of digital components based on the offline output of each digital component included in the at least one combination; and
distributing the combination of digital components based on the combination score of the given combination of digital components.

9. The method of claim 1, wherein the one input parameter that is not used by the offline evaluation model to generate the offline output is a parameter that is only accessible online by the online evaluation model.

10. A system comprising:
at least one memory device; and
one or more computing devices configured to access the at least one memory device and execute instructions stored on the at least one memory device, wherein execution of the instructions cause the one or more computing devices to perform operations comprising:
obtaining a training set of digital components;
obtaining a set of queries submitted over a past time period;
constructing a set of query-component pairs, wherein each query-component pair in the set of query-component pairs includes a query from the set of queries and a digital component from the set of digital components;
training an offline evaluation model to generate an offline output that approximates an online output of an existing online production model, wherein the existing online production model is configured to generate the online output using at least one input parameter that is not used by the offline evaluation model to generate the offline output, including:
generating, using the offline evaluation model, the offline output for each query-component pair in the set of query-component pairs to obtain a first set of offline output predictions; and
adjusting feature weights of the offline evaluation model based on a difference between the offline outputs in the set of offline output predictions and corresponding online outputs that have been generated for the set of digital components by the existing online model and using the at least one input parameter that is not used by the offline evaluation model; and
adjusting a distribution of one or more digital components based on a second set of offline output predictions generated after adjusting the feature weights if the offline evaluation model.

11. The system of claim 10, wherein:
generating the offline output comprises generating a per-query offline output for each digital component in the set of digital components using a set of features of the digital component, wherein the set of features excludes the at least one input parameter used by the online production model to generate the online output;
training the offline evaluation model includes obtaining the online output of the online production model for a set of digital components using the at least one input parameter that is excluded from the set of features used to generate the offline output by the offline evaluation model; and
adjusting feature weights of the offline evaluation model comprises adjusting parameters of the offline evaluation model in a manner that reduces a difference between the offline output for the set of digital components and the online output for the set of digital components.

12. The system of claim 11, wherein the instructions cause the one or more computing devices to perform operations further comprising generating the set of features used by the offline evaluation model, including concatenating feature embeddings of two or more of image feature embeddings, text feature embeddings, layout feature embeddings, query feature embeddings, or event feature embeddings.

13. The system of claim 12, wherein an encoder used to determine a feature embedding comprises at least one of an image encoder, a text encoder, a language model encoder, a layout encoder, or a query feature encoder.

14. The system of claim 10, wherein at least one digital component among the set of digital components is generated by generative artificial intelligence (AI) device.

15. A non-transitory computer readable medium storing instructions that, upon execution by one or more computing devices, cause the one or more computing devices to perform operations comprising:
obtaining a training set of digital components;
obtaining a set of queries submitted over a past time period;
constructing a set of query-component pairs, wherein each query-component pair in the set of query-component pairs includes a query from the set of queries and a digital component from the set of digital components;
training an offline evaluation model to generate an offline output that approximates an online output of an existing online production model, wherein the existing online production model is configured to generate the online output using at least one input parameter that is not used by the offline evaluation model to generate the offline output, including:
generating, using the offline evaluation model, the offline output for each query-component pair in the set of query-component pairs to obtain a first set of offline output predictions; and
adjusting feature weights of the offline evaluation model based on a difference between the offline outputs in the set of offline output predictions and corresponding online outputs that have been generated for the set of digital components by the existing online model and using the at least one input parameter that is not used by the offline evaluation model; and
adjusting a distribution of one or more digital components based on a second set of offline output predictions generated after adjusting the feature weights if the offline evaluation model.

16. The non-transitory computer readable medium of claim 15, wherein:
generating the offline output comprises generating a per-query offline output for each digital component in the set of digital components using a set of features of the digital component, wherein the set of features excludes the at least one input parameter used by the online production model to generate the online output;
training the offline evaluation model includes obtaining the online output of the online production model for a set of digital components using the at least one input parameter that is excluded from the set of features used to generate the offline output by the offline evaluation model; and
adjusting feature weights of the offline evaluation model comprises adjusting parameters of the offline evaluation model in a manner that reduces a difference between the offline output for the set of digital components and the online output for the set of digital components.

17. The non-transitory computer readable medium of claim 16, wherein the instructions cause the one or more computing devices to perform operations further comprising generating the set of features used by the offline evaluation model, including concatenating feature embeddings of two or more of image feature embeddings, text feature embeddings, layout feature embeddings, query feature embeddings, or event feature embeddings.

18. The non-transitory computer readable medium of claim 17, wherein an encoder used to determine a feature embedding comprises at least one of an image encoder, a text encoder, a language model encoder, a layout encoder, or a query feature encoder.

19. The non-transitory computer readable medium of claim 15, wherein at least one digital component among the set of digital components is generated by generative artificial intelligence (AI) device.
